(19) United States
(12) Patent Application Publication
(10) Pub. No.: US 2015/0363756 A1
(43) Pub. Date: Dec. 17, 2015

(54) METHOD AND SYSTEM FOR PROVIDING FITNESS CENTER ACCESS

(71) Applicant: INTELLIGENT BUSINESS INNOVATIONS, LLC, Port Huron, MI (US)

(72) Inventors: Cory Zieger, Port Huron, MI (US); Richard Quitter, Ft. Gratiot, MI (US)

(21) Appl. No.: 14/305,275

(22) Filed: Jun. 16, 2014

(51) Int. Cl. G06Q 20/14

(52) U.S. Cl. CPC G06Q 20/145

(57) ABSTRACT

One exemplary aspect of this disclosure relates to a method for admitting a user to a fitness center. The method includes a step of receiving, at a terminal, an input corresponding to an identification of a user. A disclaimer is presented to the user, on a screen of the terminal, before admitting the user to the fitness center. Further, the terminal detects whether the user has met a minimum threshold number of uses. Before the minimum threshold number of uses is met, the user is admitted to the fitness center after payment of a fee. After the minimum threshold number of uses is met, the user is admitted to the fitness center without payment of a fee.

### BACKGROUND

Gymnasiums and other fitness centers typically only allow their members to use their facilities. Gym memberships are not cost effective for users that do not use gyms frequently. Gyms often sell one-day passes, however these passes are relatively expensive. Many gym users today have a membership to a particular gym location, and do not use other gyms. When away from their “home” gym, users either pay a premium for a one-day gym pass, or simply do not work out.

### SUMMARY

One exemplary aspect of this disclosure relates to a method for admitting a user to a fitness center. The method includes a step of receiving, at a terminal, an input corresponding to an identification of a user. A disclaimer is presented to the user, on a screen of the terminal, before admitting the user to the fitness center. Further, the terminal detects whether the user has met a minimum threshold number of uses. Before a minimum threshold number of uses is met, the user is admitted to the fitness center after payment of a fee. After the minimum threshold number of uses is met, the user is admitted to the fitness center without payment of a fee.

Another exemplary aspect of this disclosure relates to a method for admitting a user to a fitness center. The method includes, among other things, a step of receiving, at a terminal, an input corresponding to an identification of a user. Further, the method detects, using the terminal, whether the user has an existing account based on the input. An account is created the user if the user does not have an existing account. Further, the terminal detects whether the user has met a minimum threshold number of uses. Before a minimum threshold number of uses is met, the user is admitted to the fitness center after payment of a fee. After the minimum threshold number of uses is met, the user is admitted to the fitness center without payment of a fee.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE DRAWINGS

The drawings can be briefly described as follows:

FIG. 1 schematically illustrates an example system according to this disclosure.

FIG. 2 is a flow chart representing an example method according to this disclosure.

### DETAILED DESCRIPTION

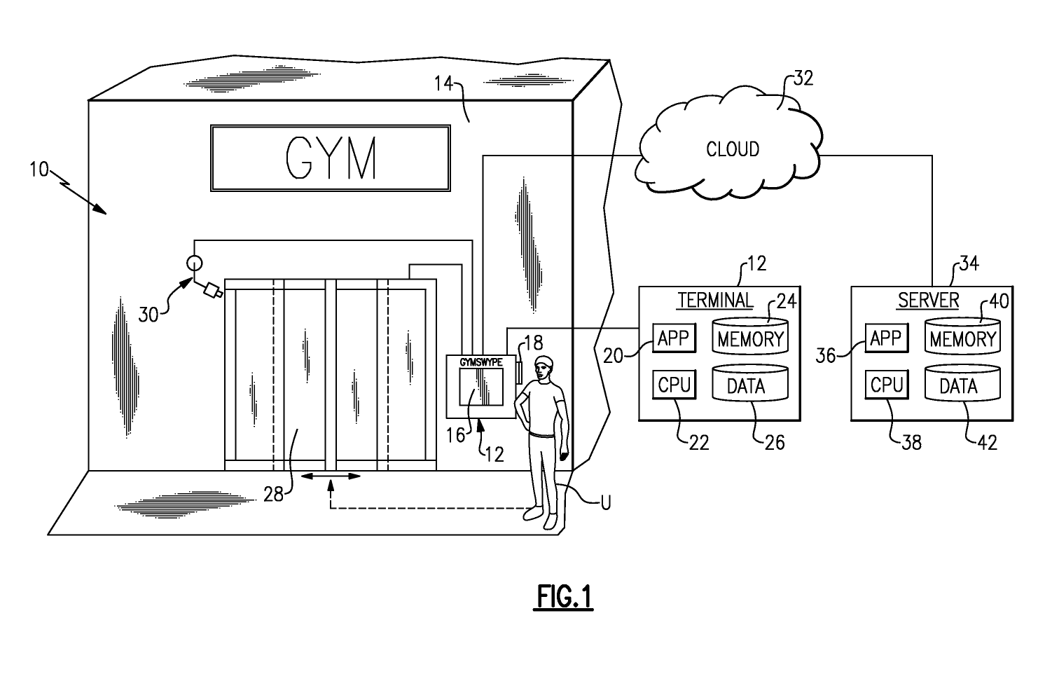

FIG. 1 illustrates an example system 10 according to this disclosure. The system 10 includes a terminal 12 configured to allow a user U access into a fitness center, such as a gymnasium (“gym”) 14. In this example, the terminal 12 is directly mounted to a front exterior wall of the gym 14. In other examples the terminal 12 may be freestanding (e.g., on a pedestal) or may be within the gym 14. The terminal 12 includes, among other things, a monitor 16, which may be a touch screen, and a reader 18. While only one terminal 12 is illustrated, the gym 14 may include multiple terminals 12.

The reader 18 illustrated herein is shown as a magnetic strip reader, such as that which is commonly used to read credit cards. It is possible for the reader 18 to be another type of reader, such as a QR code scanner, a bar code scanner, an eye or thumbprint scanner, to name a few examples.

The terminal 12 further includes one or more software applications 20, a processor 22, memory 24, and data 26. It should be understood that the terminal 12 includes other components necessary for the terminal 12 to execute the method described herein.

In this example, the terminal 12 is in communication with the front door 28 to the gym 14. The terminal 12 may be configured to open the front door 28 to grant a user U access to the gym 14. In other examples, the terminal 12 is inside the front door 28 of the gym 14. In those examples, a gym employee may monitor the front door, or there may be another access point inside the gym 14 (e.g., a turnstile). The terminal 12 may further be in communication with a security camera 30 to monitor the users entering and exiting the door 28. The camera 30 may be useful for detecting whether users U are sneaking in additional non-paying users, or whether a particular user U is sharing their account information with others.

The terminal 12 is further in communication, via a cloud 32 (i.e., the internet), with one or more servers 34. Like the terminal 12, the server 34 includes one or more software applications 36, a processor 38, memory 40, and a data storage 42 (and may include additional components, as necessary). The server 34 may be in communication with more than one terminal 12 from different gym locations, such as gyms throughout a particular geographic region. In one particular, the server 34 may be in communication with hundreds or thousands of terminals 12 at gym locations throughout the United States or worldwide.

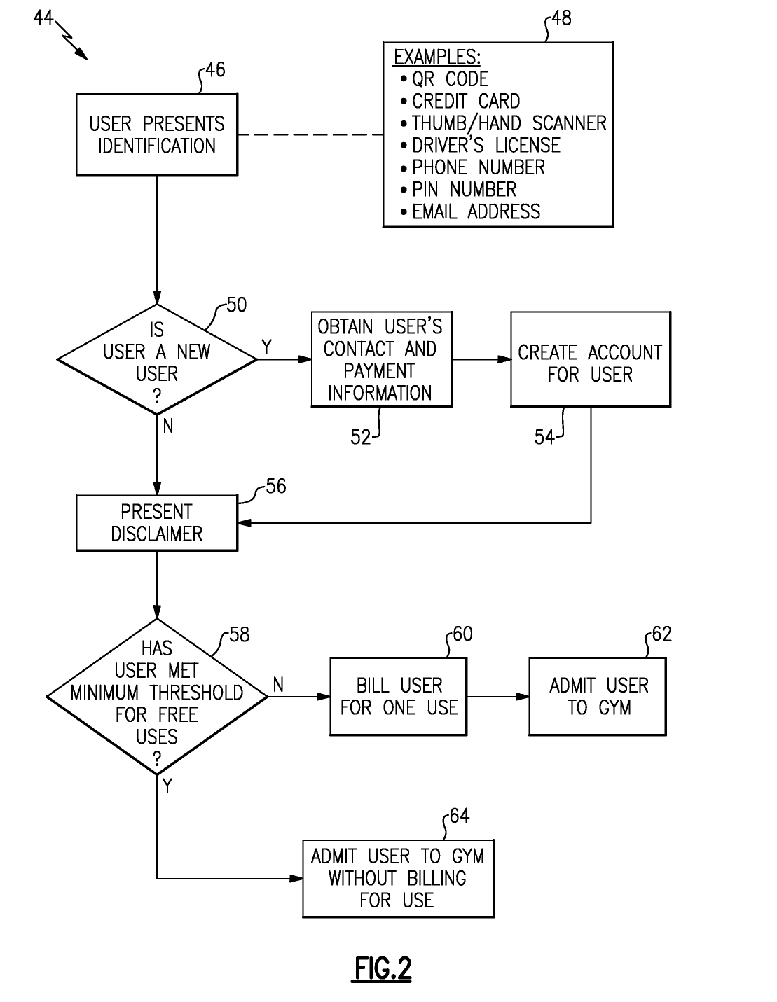

FIG. 2 illustrates an example method 44 according to this disclosure. At 46, a user U that wishes to use the gym 14 presents a form of identification at the terminal 12. Again, FIG. 1 illustrates a magnetic strip reader 18. However, as illustrated at 48, the user U may present its identification in other ways. As examples, the user may present its identification by presenting a QR code (from the user's cell phone, for example), swiping a credit card, scanning a thumb, hand, or eye, swiping a driver's license, entering a phone number, entering a unique pin number, and/or inputting an email address.

In the examples where the user U presents a QR code or enters a unique pin number, the user U may have obtained that identification by creating an account beforehand online, using an app on a mobile device (e.g., tablet or phone), or during a previous visit to the gym 14. In some embodiments, at least two identification methods are required. For example, the user U may swipe its credit card, which is only used to obtain the user's identification at this point, and then the terminal 12 may also require the user U to input a unique pin code.

Once the user U is identified, the terminal 12 detects, at 50, whether the user U has an existing account or is a new user. If the user U does not have an existing account, the user's contact and payment information are obtained, at 52. At 54, an account is created for the user U. The account information is sent to the user U for its own records, such as by text message or email. The user U may also be sent a unique pin code or a QR code for future uses. The user's account is stored on the server 34, where it can be accessed by the terminal 12 (and other terminals, which may be at different gym locations). Next, a liability-type disclaimer may be presented to the user, at 56. This disclaimer may be specific to the particular gymnasium 14.

Because consumers have grown accustomed to the flat fees associated with gym memberships, one aspect of this disclosure sets a minimum threshold number of uses within a set time period. In one example, the minimum threshold number of uses is fifteen (15) within a month. When the user U uses the gym for the fifteenth (15^{th}) time in the same month, that use is free, and any additional uses are free. In this way, the user is guaranteed a “not to exceed” billing amount within a particular time frame. This aspect of disclosure is illustrated at 58.

At 58, if the user has not exceeded the minimum threshold, in one example fifteen (15) uses per month, the user is billed for one use at 60 (e.g., by billing the stored credit card information associated with the user's account), at a set rate such as $2.99. It should be understood that the minimum threshold may be a number other than fifteen (15), the set time period may be a time period other than a month, and the set rate may be different than $2.99. More “premium” gyms, for example, may charge more than $2.99. In other examples, “premium” gyms may not count toward a user's minimum threshold, or there may be different requirements for receiving free access to “premium” gyms.

After payment is confirmed, the user is admitted to the gymnasium, at 62. If the user has met the minimum threshold uses, (e.g., this is the user's fifteenth (15^{th}) use of the month), the user is admitted to the gym, at 64, without billing for that particular use.

With this disclosure, a user U can go to any number of gyms 14 that employ the system 10. The gyms 14 employing the system 10 are referred to herein as “networked fitness centers.” By communicating over the cloud 32 with the server 34, the system 10 can globally monitor the amount of uses accumulated by each user U between all of the networked fitness centers. Further, the users can find the networked fitness centers in some examples using a “gym locator” feature on a website or mobile device app.

Thus, in continuing with the example above, a user who lives in Port Huron, Michigan and has used a first networked fitness center in Port Huron fourteen (14) times in a month, can then use a second networked fitness center on a business trip to Chicago, Illinois later in the month. The usage in Chicago—the fifteenth (15^{th}) of the month—would be free. When user returns home to Port Huron, the remaining uses in Port Huron are also free for that month.

When visiting different networked fitness center locations, the user U does not need to create an account at each gym. The system 10 allows a particular user U to essentially have a “membership” to a number of different gyms. This system and method is particularly beneficial to those that travel, and to those that do not use gymnasiums often enough to make a full-time membership worthwhile. On the other hand, the system is beneficial to those that work out very often, as these individuals will exceed the minimum number of uses (from step 58) quickly. This system and method further streamlines the process of signing up new gym members, and reduces staffing requirements on gymnasiums.

Although the different examples have the specific components shown in the illustrations, embodiments of this disclosure are not limited to those particular combinations. It is possible to use some of the components or features from one of the examples in combination with features or components from another one of the examples.

One of ordinary skill in this art would understand that the above-described embodiments are exemplary and non-limiting. That is, modifications of this disclosure would come within the scope of the claims. Accordingly, the following claims should be studied to determine their true scope and content.

What is claimed is:

1. A method for admitting a user to a fitness center comprising:
receiving, at a terminal, an input corresponding to an identification of a user;
presenting a disclaimer to the user, on a screen of the terminal, before admitting the user to the fitness center;
detecting, using the terminal, whether the user has met a minimum threshold number of uses;
admitting the user to the fitness center after payment of a fee if the minimum threshold number of uses is not met; and
admitting the user to the fitness center without payment of a fee if the minimum threshold number of uses is met or exceeded.

2. The method as recited in claim 1, wherein the minimum threshold number of uses is a minimum threshold number of uses within a set time period.

3. The method as recited in claim 2, wherein the set time period is one month.

4. The method as recited in claim 1, wherein the fitness center is one of a plurality of networked fitness centers.

5. The method as recited in claim 4, wherein the admittance of a user to any of the networked fitness centers counts toward the minimum threshold number of uses.

6. The method as recited in claim 4, wherein the networked fitness centers are located at different geographical locations.

7. The method as recited in claim 1, wherein, the input is provided by at least one of (1) a QR code, (2) a credit card, (3) a scanned body part, (4) a driver's license, (5) a phone number, (6) a pin number, and (7) an email address.

8. The method as recited in claim 7, further comprising:
detecting whether the user has an existing account based on the input.

9. The method as recited in claim 8, further comprising:
creating an account for the user if the user does not have an existing account.

10. The method as recited in claim 9, further comprising:
storing the account on a server, the server in communication with the terminal.

11. A method for admitting a user to a fitness center comprising:
receiving, at a terminal, an input corresponding to an identification of a user;
detecting, using the terminal, whether the user has an existing account based on the input;
creating an account for the user if the user does not have an existing account;
detecting, using the terminal, whether the user has met a minimum threshold number of uses;
admitting the user to the fitness center after payment of a fee if the minimum threshold number of uses is not met; and
admitting the user to the fitness center without payment of a fee if the minimum threshold number of uses is met or exceeded.

12. The method as recited in claim 11, further comprising:
storing the account on a server, the server in communication with the terminal.

13. The method as recited in claim 11, wherein the minimum threshold number of uses is a minimum threshold number of uses within a set time period.

14. The method as recited in claim 13, wherein the set time period is one month.

15. The method as recited in claim 11, wherein the fitness center is one of a plurality of networked fitness centers.

16. The method as recited in claim 15, wherein the admittance of a user to any of the networked fitness centers counts toward the minimum threshold number of uses.

17. The method as recited in claim 15, wherein the networked fitness centers are located at different geographical locations.

18. The method as recited in claim 11, wherein, the input is provided by at least one of (1) a QR code, (2) a credit card, (3) a scanned body part, (4) a driver's license, (5) a phone number, (6) a pin number, and (7) an email address.
